(19) United States
(12) Patent Application Publication
(10) Pub. No.: US 2016/0283920 A1
(43) Pub. Date: Sep. 29, 2016

(54) AUTHENTICATION AND VERIFICATION OF DIGITAL DATA UTILIZING BLOCKCHAIN TECHNOLOGY

(71) Applicants: Justin Fisher, Delray Beach, FL (US); Maxwell Henry Sanchez, Albuquerque, NM (US)

(72) Inventors: Justin Fisher, Delray Beach, FL (US); Maxwell Henry Sanchez, Albuquerque, NM (US)

(21) Appl. No.: 15/083,238

(22) Filed: Mar. 28, 2016

Related U.S. Application Data
(60) Provisional application No. 62/139,655, filed on Mar. 28, 2015.

(51) Int. Cl. G06Q 20/06; H04L 9/30; H04L 9/06; H04L 9/08; H04L 9/32; H04L 29/06

(52) U.S. Cl. CPC G06Q 20/065; H04L 9/3247; H04L 63/083; H04L 9/0643; H04L 9/0861; H04L 9/30; H04L 63/06; H04L 2209/56

(57) ABSTRACT

A method for authenticating a chain of custody utilizing blockchain technology, whereby digital evidence or other digital content is acquired and then hashed to produce a hash fingerprint/signature and then immediately or instantly submitting said hash fingerprint/signature to the blockchain using the blockchain network protocol, forming an immediate verifiable chain of custody without human interaction or requiring a trusted third party.

### CROSS-REFERENCE TO RELATED APPLICATIONS

This application claims priority to U.S. Provisional Application No. 62/139,655, filed Mar. 28, 2015, which is incorporated herein by reference for all purposes.

### BACKGROUND OF THE INVENTION

This invention is in the field digital content and data authentication and providing verification.

Law enforcement agencies are required to record and maintain chains of custody for items of evidence involved in any investigation. Such a chain of custody serves the primary purpose of ensuring that evidence was not tampered with, while also documenting the initial collection time. On the occasion that disputes arise regarding the validity of evidence, the paper trail can be back-traced to provide information regarding the handling of evidence for the primary purpose of proving the evidence has not been tampered with or planted. There are many uses for this method in connection with many industries, and evidence in connection with legal issues is only one type of digital data or content that can be authenticated and receive the benefits if this method is used in connection with the digital data collection process.

Normally, this process would involve documenting time and location any person or system was permitted access to the evidence, either for examination or transport. However, if there existed a method for provably certifying that the evidence existed exactly as it had when the chain of custody was initially created, much of the chain of custody would become unnecessary.

### BRIEF DESCRIPTION OF THE SEVERAL VIEWS OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates the logic and programmatic flow associated with submitting a file's existence to the Bitcoin blockchain.

FIG. 2 illustrates the process of generating a Bitcoin address containing desired text, used in creating a Bitcoin address including one half of the base58-converted hash of a file one wishes to prove to the blockchain.

FIG. 3 illustrates the logic and programmatic flow associated with using a basic API for a client to securely communicate their file through a third-party service to the Bitcoin blockchain without revealing the original file.

FIG. 4 illustrates a cryptographic hash function (specifically, SHA-1) at work. Note that even small changes in the source input (here in the word “over”) drastically change the resulting output, by the so-called avalanche effect.

FIG. 5 depicts a user function flowchart of performing the tasks of posting a hash file or address in a blockchain and retrieving the hash file to authenticate the original digital file that produced the hash.

### DETAILED DESCRIPTION OF THE INVENTION

Detailed descriptions of particular embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the instant invention has been shown and described in accordance with preferred and practical embodiments thereof, it is recognized that departures from the instant disclosure are contemplated within the spirit and scope of the present invention. Therefore, the true scope of the invention should not be limited since other modifications will become apparent to those skilled in the art upon a study of the claims, drawings, descriptions, explanations, and specifications herein.

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### COMPONENT LIST FOR DRAWINGS

Following is a partial list of the components depicted in the drawings:

| Component | |
|---|---|
| Number | Component Description |
| 1 | digital document and/or digital content |
| 2 | content Hex conversion |
| 3 | Hex to base58 conversion |
| 4 | base58 word split |
| 5 | Generating Bitcoin address with desired string |
| 6 | payment is made of 5461 satoshis to each generated |
| | Bitcoin address |
| 11 | append 1 to beginning and trailing 5 s to the end |
| 12 | base58 to Hex conversion |
| 13 | remove last four bytes |
| 14 | double hashed |
| 15 | append first eight bytes |
| 16 | hex to base58 conversion |
| 18 | A append |
| 19 | B append |
| 31 | Login |
| 32 | approve login |
| 33 | send hashed file to server |
| 34 | server sends Transaction ID to client |
| 90 | client |
| 91 | server |
| 641 | first 64 hex character word |
| 642 | second 64 hex character word |
| 51 | log-in |
| 52 | receives approval of log-in |
| 53 | acquiring of digital data |
| 54 | creates hash file from digital data |
| 55 | transmits hash file and/or hash blockchain to server |
| 56 | receives transaction confirmation and/or identifier |
| | from server |
| 57 | create a second and/or other hash file from digital data |
| 58 | receiving hash file and timestamp from server |
| 59 | compares hash file to second and/or other hash file |
| 591 | Are they same or different? |
| 592 | results are displayed of comparison in at least one |
| | unique format |
| 593 | Files are not equal |
| 594 | Files are equal |

### DETAILED DESCRIPTION OF THE DRAWINGS

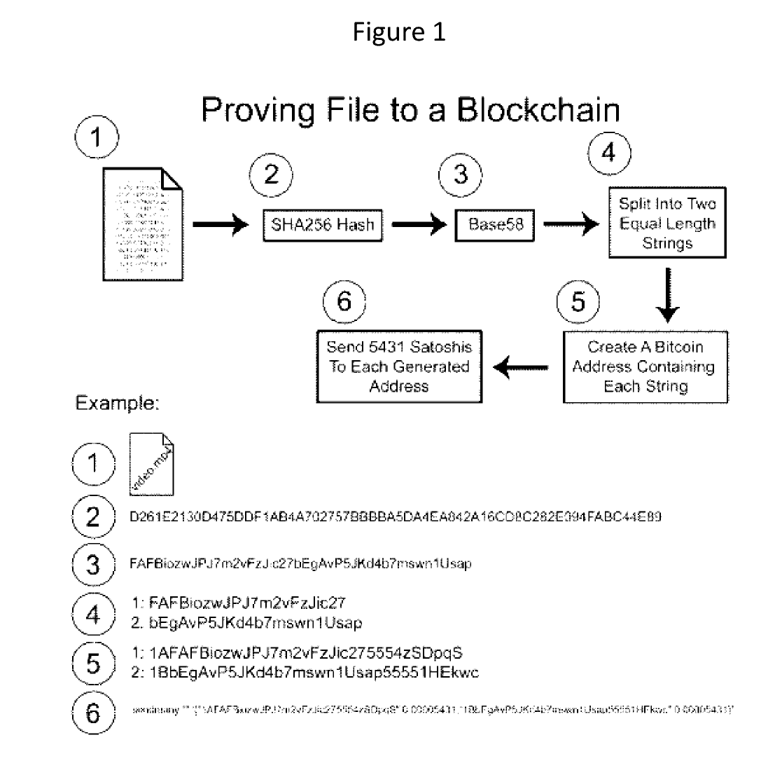

FIG. 1 illustrates the logic and programmatic flow associated with submitting a file's existence in a particular form to the Bitcoin blockchain. Note that Bitcoin is just one of many blockchains that information can be posted to, and Bitcoin is shown for example only.

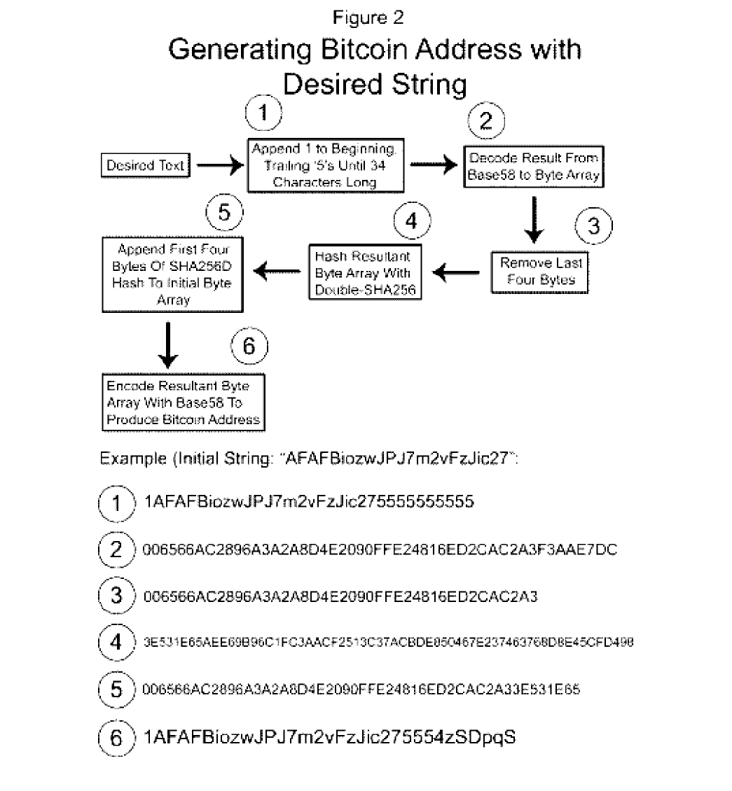

The process begins with digital document and/or digital content 1. SHA-256 is a publically available algorithm for encoding digital data, and in this example, digital document and/or digital content 1 is being acted upon by SHA-256 to produce content Hex conversion 2, which creates 64 hex characters to represent a unique signature of digital document and/or digital content 1. 64 Hex characters represents 256 bits of information, which represents approximately 1.15792 X ten to the 77^{th} power, which is a huge number. The key to producing this 64 character hash is the extreme improbability of any other source of digital data producing this same hash. In the process depicted in this FIG. 1. The next step is Hex to base58 conversion 3 which converts the 64 Hex character hash to a base58 format which is used in Bitcoin as well as other networks and/or systems. This is usually a modulo conversion from Hex base16 to base58, and this produces 44 base58 characters. This invention then, for added security, employs base58 word split 4 to split the 44 base58 characters into two 22 Base58 character strings. Bitcoin requires a minimum of 34 base58 characters, Generating Bitcoin address with desired string 5 is the next step in the process, which converts the 22 base58 character into a 34 base58 character string, and this process is outlined in FIG. 2, which illustrates the process of generating a Bitcoin address containing desired text, used in creating a Bitcoin address including one half of the base58-converted hash of a file one wishes to prove to the blockchain. Because there are two 22 base58 character strings generated in base58 word split 4 of FIG. 1, an “A” in A append 18 was appended to the first base58 word and a “B” in B append 19 was appended to the second base58 word to produce a pair of 23 base58 character words. Next, a 1 is appended to each word to produce a pair of 24 base 58 character words. Trailing 5s are then added to make up the difference and produce a pair of 34 character words. One word is shown, and in step append 1 to beginning and trailing 5s to the end 11, the result is a 34 base58 character word. Next a base58 to Hex conversion 12 is performed, which yields a hex string of characters that in this case is 50 Hex characters long. The remove last four bytes 13 removes the last 8 hex characters from the string, thus producing 42 Hex characters. This result is double hashed in double hash 14 to produce a 64 hex character string. The process is as follows: the 42 Hex characters are hashed once using SHA-256 to produce a first 64 hex character word 641. This is hashed a second time using SHA-256 to produce second 64 hex character word 642. The first four bytes or eight hex characters are removed and added to the original 42 Hex characters in append first eight bytes 15 to produce a new 50 hex character word. This is then converted using hex to base58 conversion 16, and this is the final Bitcoin address.

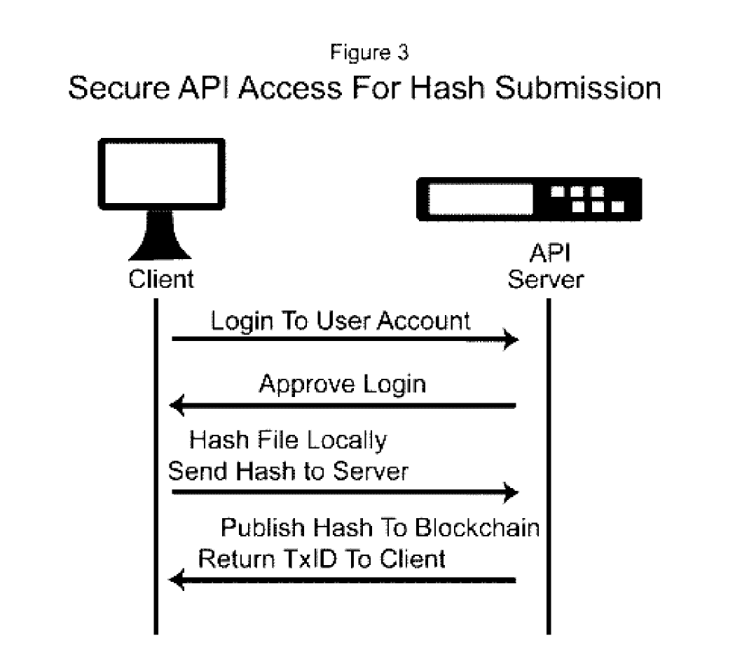

Returning to FIG. 1, the process outlined in FIG. 2 must be repeated twice because there are two 22 base58 characters to be converted into two base58 34 character long strings. These two 34 base58 character strings are two viable Bitcoin address, and they can be subsequently posted, and when posted payment is made of 5461 satoshis to each generated Bitcoin address 6. This posting can either be done directly or the two viable Bitcoin addresses are used as depicted in FIG. 3.

FIG. 3 illustrates the logic and programmatic flow associated with using a basic API for a client to securely communicate a file through a third-party service to the Bitcoin blockchain without revealing the original file. In this case, the client 90 would Login 31 to the server 91. Server 91 would then approve login 32. Client 90 would then either perform all the steps outlined in FIG. 1 and FIG. 2, and these would be and provide the data used to send hashed file to server 33. The server 9lwould then post the two 34 base58 character words or addresses to the Bitcoin network or blockchain, and the server sends Transaction ID to client 34.

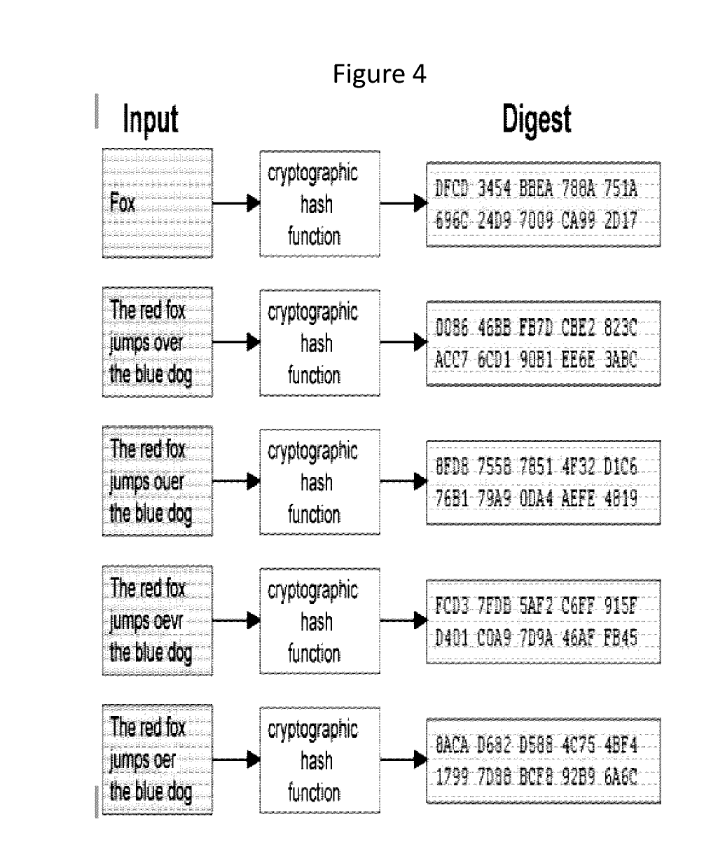

FIG. 4 illustrates a cryptographic hash function (specifically, SHA-1 which produces 160 bits) at work. The result of the SHA-1 conversion is depicted as 40 hex characters. Each of the four conversions shown produce 40 hex characters. What can be seen by inspection is that even a small change of only one character (here in the word “over”) produces a radical change in the result, or a so called avalanche effect. Also, a 160 bit result produces roughly 1.46 X 10 to the 48^{th} power, which is a huge number, and the odds of two different starting strings producing the same hashed result are astronomically small. Thus, if a digital document and/or digital content produces the same hashed result, the documents and/or digital content is identical and can meet the standard of “beyond reasonable doubt”. This makes this encoding method and comparison strategy very useful in proving that data has not been corrupted either accidentally or intentionally. A one pixel alteration can produce a profoundly different hash, and this can be demonstrated in a courtroom or other venue.

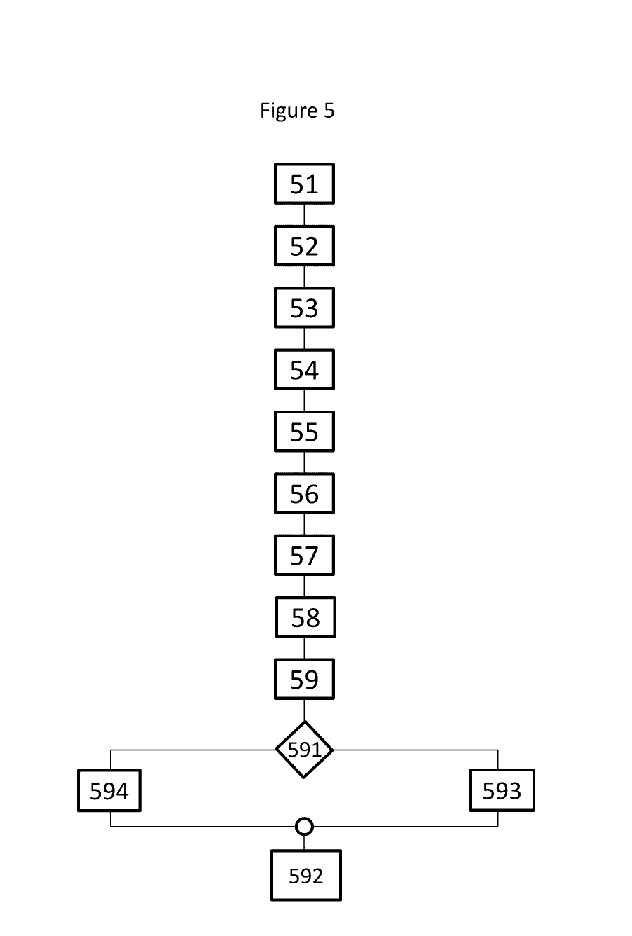

FIG. 5 depicts a user function flowchart of the performing of posting a hash file or address in a blockchain and retrieving the hash file to authenticate the original digital file that produced the hash.

The user performs the log-in 51 function. The user then receives approval of log-in 52. The user then engages in acquiring of digital data 53, which can be and digital data and/or digital content from any source. The user then creates hash file from digital data 54, then transmits hash file and/or hash blockchain to server 55. The user then receives transaction confirmation and/or identifier from server 56. To confirm at some time in the future that the originating document that produced the original file is the same and has not been adulterated, the user must then create a second and/or other hash file from digital data 57. The user then receives hash file and timestamp from server 58. The user then, using the specialized user software application, compares hash file to second and/or other hash file 59. Then the determination must be made: Are they same or different? 591. Either the files are not equal 593 or the files are equal 594, and the results are displayed of comparison in at least one unique format 592.

### Definitions

These definitions are in addition to the words and phrases specifically defined in the body of this application.

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

“Blockchain”: a peer to peer decentralized open ledger, like “bitcoin” architecture, relies on a distributed network shared between its users—everyone holds a public ledger of every transaction carried out using the architecture, which are then checked against one another to ensure accuracy. This ledger is called the “blockchain”. Blockchain is used instead of a centralized third party auditing and being responsible for transactions. The blockchain is a public ledger that records bitcoin or “cryptocurrency” transactions. A novel solution accomplishes this without any trusted central authority: maintenance of the blockchain is performed by a peer-to-peer network of communicating nodes running bitcoin or software. Transactions of the form payer X sends Y bitcoins to payee Z are broadcast to this network using readily available software applications. Network nodes can validate transactions, add them to their copy of the ledger, and then broadcast these ledger additions to other nodes. The blockchain is a distributed database; in order to independently verify the chain of ownership or validity of any and every bitcoin (amount), each network node stores its own copy of the block chain. Approximately six times per hour, a new group of accepted transactions, a block, is created, added to the block chain, and quickly published to all nodes. This allows bitcoin software to determine when a particular bitcoin amount has been spent, which is necessary in order to prevent double-spending in an environment without central oversight. Whereas a conventional ledger records the transfers of actual bills or promissory notes that exist apart from it, the block chain is the only place that bitcoins or a given cryptocurrency can be said to exist in the form of unspent outputs of transactions.

Tampering with transactions on the blockchain becomes exponentially harder as time progresses, and requires extreme quantities of computing power to attempt. Data stored in the blockchain is included in integrity checks—transactions are assembled into a transaction merkle tree and hashed to produce a block header. Any alterations to transactions in a blockchain database would become apparent as the block would be invalid when indexed. Rewriting blocks requires a network forking attack, and even read-write access to every peer on the network would not provide sufficient resources to alter a transaction included into the blockchain.

As such, the Blockchain of Consensus allows a file's hash to be published to the blockchain as irrefutable proof that the file existed at a given time in the past. Both the timestamp and the hash are unalterable barring attacks of extreme cost against the entire network.

“Cryptographic Hash” or “Hash”: a cryptographic hash function is a hash function which is considered practically impossible to reverse, more specifically, to recreate the input data from its hash value alone. These one-way hash functions are an essential part of the blockchain. The input data is often called the message, and the hash value is often called the message digest or simply the digest. The ideal cryptographic hash function has four main properties: (1) it is easy to compute the hash value for any given message; (2) it is infeasible to generate a message from its hash; (3) it is infeasible to modify a message without changing the hash; and (4) it is infeasible to find two different messages with the same hash. Cryptographic hash functions have many information security applications, notably in digital signatures, message authentication codes (MACs), and other forms of authentication. They can also be used as ordinary hash functions, to index data in hash tables, for fingerprinting, to detect duplicate data or uniquely identify files, and as checksums to detect accidental data corruption. Indeed, in information security contexts, cryptographic hash values are sometimes called (digital) fingerprints, checksums, or just hash values, even though all these terms stand for more general functions with rather different properties and purposes. HASH Examples: (FIG. 4)
User Smart Device: A user smart device can be more than one smart device. It can be a mobile device, laptop, tablet, mainframe computer, desktop computer, server, and/or super computer, and can contain or be connected to at least one camera, reader device, input device and/or scanner. A user smart device can have internet connection capability and have at least one browser.
Server: A server can be at least one server, and can be at least one computer and/or smart device acting as a server and/or source of information which is provided to at least one other smart device upon request. A server can be a database in whole or in part that can be accessed by at least one smart device. A server can host one or more websites and/or browsers, and can be addressed with at least one URL and/or name and/or can be found via at least one search engine operated to locate at least one data located on the server.
User: a user can be a single user or more than one user
Timestamp—a time associated with the time received and/or the time of creation or changing of digital data and/or digital content
Hash: A code and/or sequence of characters of a particular base that is a unique representation of digital data and/or digital content. SHA-256 is one such representative program that can produce a hash, but many algorithms can be used to produce a hash of starting digital data and/or digital content. The base can be hex, base58, and/or any other base, and is not limited to the common bases used presently in commercial applications.
Predetermined interval can be an interval of a constant period of time. For instance, if a video that is four minutes long, a hash can be generated for each second of video. If a camera is hypothetically recording moving images at 30 frames per second, four minutes of video would produce 30 frames per second×240 seconds, or 7,200 total frames of video. If a predetermined interval is one second, then there would be 240 blocks of data. In the context of this invention, one hash could be produced that represents each block of data, and thus 240 blocks of data would produce 240 unique hashes. These hashes could subsequently be combined in a Merkle tree to yield one master hash which can represent all the digital data acquired in the four minute video.
   Any number of hashes can be combined in different ways to produce intermediate hashes, but the predetermined interval would determine the beginning and end of a block of data acquired as a function of time and/or space and/or N-dimensional space to be hashed.

1. The present invention is an improvement on authentication and/or verification of digital data and/or digital content and/or a chain of custody of digital data and/or digital content utilizing a user smart device running a specialized user software application and/or embedded user software application and a server smart device running a specialized server software application performing a transformation or a transformation and encryption or encryption and transformation on said digital data and/or digital content to produce at least one unique hash or at least one unique hash at at least one predetermined interval, and to submit or post said unique hash to at least one blockchain using at least one blockchain network protocol, and to read said at least one hash and compare to at least one other hash for authentication and/or verification comprising:
Hardware comprising:
a user smart device running a specific user software application operated by a user, said user smart device engaging in at least one specific communication with a server smart device;
said server performing at least one communication with the said user smart device, said server performing at least one of the following: storage of at least one data base or a portion thereof and/or data for placement therein, access said at least one data base, update said at least one data base, enable said user smart device to access and receive information in whole or in part from said at least one data base or a portion thereof, said at least one data base containing said at least one unique hash, at least one timestamp of said at least one unique hash, and/or other data;
Software on user smart device performing at least one of the following:
at least one sign-in and/or log-in using at least one one factor identification at at least one time;
receiving of at least one approval of said sign-in and/or log-in;
acquiring of digital data and/or digital content;
creating of at least one hash from said digital data and/or digital content;
transmitting of at least one hash file and/or hash blockchain to said server;
receiving at least one transaction confirmation and/or identifier from said server smart device;
creating and/or recreating at least one second and/or other hash file and/or hash blockchain from said digital data and/or digital content;
receiving at least one hash file and/or hash blockchain and at least one timestamp from said server smart device;
comparing said at least one hash file and/or hash blockchain to said at least one second and/or other hash file and/or hash blockchain and determining whether they are the same or different;
displaying result of said comparing in at least one unique format;
Software on server smart device performing at least one of the following:
receiving of at least one sign-in and/or log-in by said user;
transmitting at least one approval of sign-in and/or log-in;
receiving of said at least one hash file and/or hash blockchain from at least one user;
entering said at least one hash file and/or hash blockchain into at least one database;
posting for public viewing as a read only file said at least one said hash file and/or hash blockchain and at least one timestamp;
sending at least one transaction confirmation and/or identifier to said user smart device;
enabling the download of said read only file of said at least one hash file and/or hash blockchain and at least one timestamp in a format easily usable by said user;

2. The invention of claim 1 wherein said at least one blockchain network protocol is at least one of the Bitcoin block transaction and address format, the Ethereum block transaction and address format, the Bitcoin block transaction and address format, the Peercoin block transaction and address format, or another format or formats by which data can be containerized or encoded such that a network decentralized or otherwise can read, transmit, relay, interpret, and/or store data in whole or in part.

3. The invention of claim 1 wherein said user software application and/or said embedded user software application enables said digital data and/or digital content to be generated continuously or at at least one predetermined interval to encompass the period of time before an event of interest, during said event of interest, and after said event of interest to encompass said event of interest, then to create at least one representative hash and/or hash blockchain derived from said digital data and/or digital content.

4. The invention of claim 3 wherein said at least one predetermined interval is at least one of automatically determined, manually selectable, selectable from at least one menu of choices.

5. The invention of claim 3 wherein said digital data and/or digital content of interest produces said at least one hash in at least one of the following ways: automatically, timer based, immediately, delayed by a predetermined period of time after acquisition of said digital data and/or digital content, manually triggered and/or automatically triggered, scheduled, or other criteria used to initiate production of at least one hash.

6. The invention of claim 1 wherein said at least one unique hash is integrated into a block on at least one blockchain.

7. The invention of claim 5 wherein said block is further reproduced on at least one other blockchain.

8. The invention of claim 1 wherein said blockchain is or involves at least one Merkle tree.

9. The invention of claim 8 wherein said Merkle tree is updated at regular and or irregular intervals.

10. The invention of claim 1 further comprising a decentralized mechanism by which a consensus network can publish data to one or more other networks, decentralized or otherwise.

11. The invention of claim 1 wherein said digital data and/or digital content is encrypted and/or unencrypted and is at least one of a photograph, video, screen grab, word processed document, text and/or text string or file, e-mail, instant message from any digital device and/or system and/or network supporting instant messaging, posts to any social media now known or unknown, any digital device, piece of electronic equipment where data can be stored, test equipment, manufacturing equipment, process controller, appliance, television and/or cable device, at least one setting on any device now known or unknown, and or any other source that contains or stores digital file, array, or extractable said digital data and/or digital content.

12. The invention of claim 1 further comprising payment or exchange of cryptocurrency and/or other currency as a result of certain network-based transactions.

13. The invention of claim lwherein said digital data and/or digital content is evidence deriving from at least one of a digital content acquisition device including but not limited to a camera, a smart device, a smartphone, a computer, a disk and/or hard drive, a thumb drive, flash memory, RAM, ROM, EPROM, an answering machine, digitized video tape, surveillance video, CD ROM or DVD, any digital video game or digital video game that communicates with the web, wearables, or any source now known or unknown.

14. The invention of claim 1 further comprising the submission of hash fingerprint and/or signature immediately upon acquisition to the blockchain forming verifiable and/or immediately verifiable authentication of said digital data and/or digital content without human interaction or requiring a trusted third party authentication.

15. The invention of claim 14 further comprising creation of and/or enforcement of redundancy across multiple consensus networks comprising at least one of:
a. the publishing of arbitrary data to multiple consensus networks simultaneously and/or sequentially;
b. the determination of which submission provides the earliest timestamp;
c. creation of a data mirroring function to submit said data to multiple networks with at least one request;
d. employment of at least one machine learning algorithm to adapt to network conditions;
e. deciding which network or networks to submit said data to in order to ensure a level of data parity;
f. the combination and/or merging of multiple requests into one lead request in at least one combined data structure.

16. The invention of claim 1 further comprising at least one of the following:
a. the collection of and/or generation of digital data and/or digital content;
b. the creation of and local storing of at least one hash of said digital data and/or digital content;
c. the formatting of said at least one hash for inclusion into at least one blockchain and/or blockchain network;
d. the examination and/or analysis and/or comparison of said at least one hash for previous inclusion of said at least one hash in at least one said blockchain network;
e. submission of said at least one hash to at least one said blockchain network and recording submission identification;
f. making at least one query of at least one said blockchain network to confirm inclusion of said at least one hash and/or to confirm said inclusion and propagation within at least one said blockchain network;
g. upon confirmation of said inclusion, recording a unique identifier to at least one database;
h. issuance of notification with receipt of transaction and/or other related information specific to at least one said blockchain network including but not limited to publication time, network priority, network access details, and/or other information required by a user.

17. The invention of claim 1 wherein retrieving previously published information on at least one blockchain comprises at least one of the following:
a. using previously-provided identification and/or receipt and/or confirmation data to extract and/or query at least one blockchain network for at least one submission detail;
b. parsing at least one returned transaction information into a readable unique format;
c. regeneration and/or reacquisition of digital data and/or digital content requiring authentication and/or verification through the use of at least one comparison between at least two hashes;
d. confirmation of the existence of checked data in the returned and/or retrieved transaction;
e. verification and/or authentication and/or re-verification and/or re-authentication of the structure of returned data using at least one cryptographic function to confirm legitimacy in at least one network's chain of data.

18. The invention of claim 17 wherein said retrieving previously published information on at least one blockchain is used for re-acquiring said previously published information to confirm the authenticity and/or validity of said digital data and/or digital content comprising at least one of the following:
a. computing the checksum and/or hash of said digital data and/or digital content using the same method as originally used to produce said checksum and/or hash;
b. looking up and/or retrieving the original transaction and/or publication of data with at least one stored reference and/or re-query to re-acquire said reference for additional security if said reference is lost;
c. verification of said checksum and/or hash to confirm equivalency to original data extracted from at least one network consensus transaction and/or publication;
d. lookup of inclusion details for transaction to acquire a timestamp of initial publication;
e. publication including said timestamp in at least one consensus network in the event of said equivalency.

19. The invention of claim 1 wherein said digital data and/or content and/or at least one hash is generated automatically in response to at least one other action.
